(19) United States
(12) Patent Application Publication
(10) Pub. No.: US 2006/0230953 A1
(43) Pub. Date: Oct. 19, 2006

(54) Screenprint process apparatus and method of use

(76) Inventor: Jeff Brandes, Cat Spring, TX (US)

Correspondence Address: DUANE, MORRIS, LLP, 3200 SOUTHWEST FREEWAY, SUITE 3150, HOUSTON, TX, 77027, US

(21) Appl. No.: 11/107,015

(22) Filed: Apr. 15, 2005

(51) Int. Cl. B41F 15/18; B41F 15/26

(52) U.S. Cl. 101/129; 101/114

(57) ABSTRACT

A screenprint tool adapted for substantially simultaneous screenprinting of a plurality of surfaces is disclosed. A top surface planar member comprises a plurality of inlets defining a corresponding plurality of arms and a channel intermediate the arms. The tool may be removably mounted to a mounting surface. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### FIELD OF INVENTION

The present inventions relate generally to the field of screenprinting. More particularly, the present inventions relate to a tool for holding one or more materials, objects, or the like for substantially simultaneous screenprinting.

### BACKGROUND OF THE INVENTION

Serigraphy, more commonly known as screen printing, is one of the most common and versatile printing processes in use today. Screen printing can be applied to a wide variety of surfaces including paper, cardboard, glass, wood, plastic, posters, bottles, electronic circuits, and the like, and to an equally wide variety of shapes. The screen printing process consists generally of forcing an ink, by pressure applied via a squeegee, through the mesh of a screen stretched on a frame and onto the object to which the desired image is intended to be transferred.

Many improvements in the art for holding materials have been proposed, mostly addressing tension of printing screens. However, numerous items exist for which use of such screens is either not practical or slows down the screen print process. Notably, the art lacks a useful tool that can hold a plurality of such objects, e.g. coozie cups or wearable items, to allow substantially simultaneous screen printing of that plurality.

Additionally, a movable tool would be useful.

### BRIEF DESCRIPTION OF THE DRAWINGS

FIG. 1 is a top down view in partial perspective of an embodiment of the present inventions;

FIG. 2 is side view in partial perspective of an embodiment of the present inventions;

FIG. 3 is side view in partial perspective of an alternate embodiment of the present inventions;

FIG. 4 is bottom up view in partial perspective of the present inventions; and

FIG. 5 is a flowchart of an exemplary method of the present inventions.

### BRIEF DESCRIPTION OF AN EMBODIMENT OF THE INVENTION

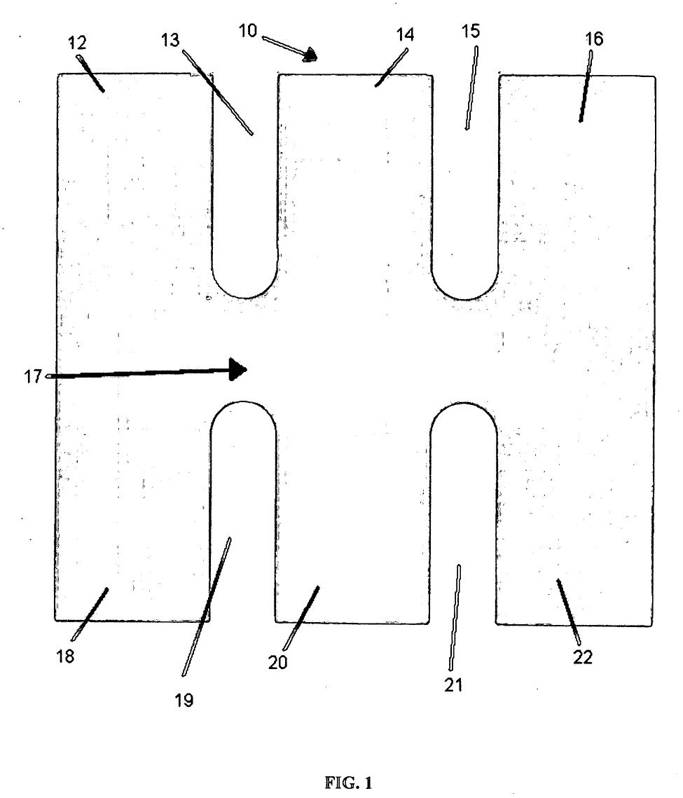

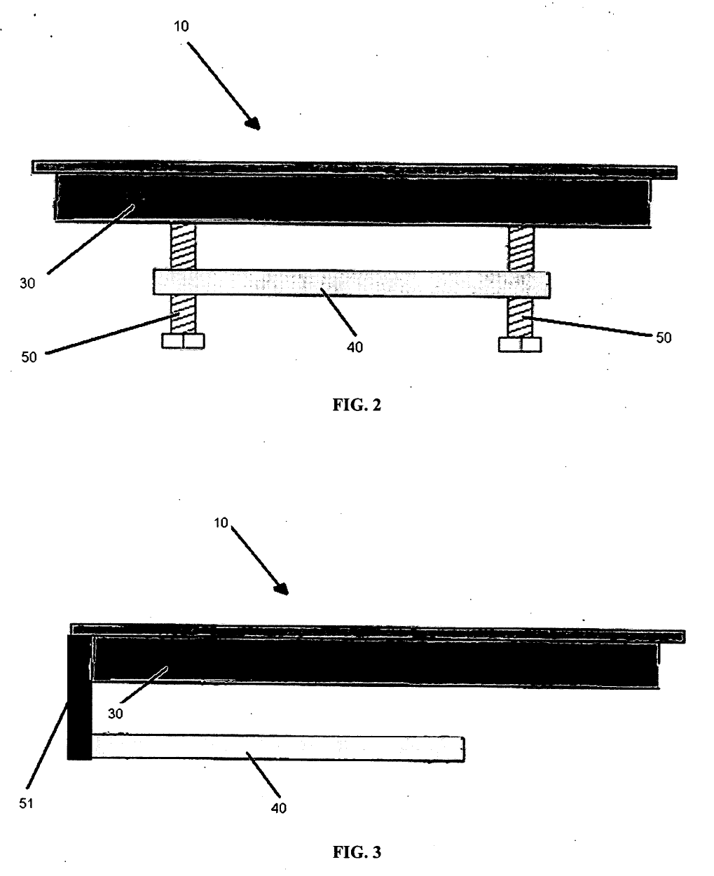

Referring now to FIGS. 1-4, in a preferred embodiment screenprint tool 10 comprises first substantially planar member 11, second substantially planar member 30 (FIG. 2) disposed about a surface of first substantially planar member 11, third substantially planar member 40 (FIG. 2), and adjuster 50 (FIG. 2) in movable communication with second substantially planar member 30 and third substantially planar member 40.

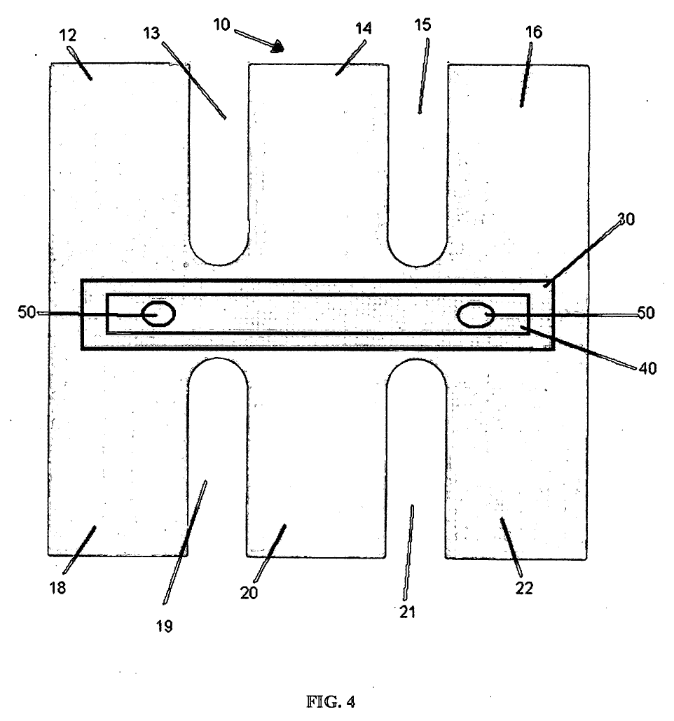

Referring now to FIG. 3, in an alternative embodiment, second substantially planar member 30 may be connected to or otherwise in communication with third substantially planar member 40 by a flexible adjuster 51. In this embodiment, second substantially planar member 30, third substantially planar member 40, and flexible adjuster 51 may be fabricated as a unitary piece or as two or three pieces separate pieces.

Referring now to FIG. 1, in preferred embodiments, first substantially planar member 11 has a length of around 12-14 inches with a preferred length of around 13 inches and a width of between 10 and 14 inches with a preferred width of around 12 inches. First substantially planar member 11 made comprise any appropriate material, e.g. plastic or wood or metal.

First substantially planar member 11 further comprises a plurality of inlets 13, 15, 19, 21. As will be apparent to those of ordinary skill in the mechanical arts, the actual number of inlets 13, 15, 19, 21 may vary, e.g. only inlets 13 and 19 may be present or a greater number of 13, 15, 19, 21 may be present. In preferred embodiments, inlets 13, 15, 19, 21 intrude around 4 to 6 inches into the width of first substantially planar member 11, depending, of course, on the width of first substantially planar member 11. For widths of around 12 inches, inlets 13, 15, 19, 21 intrude around 5 inches and comprise a gap of around between 1 to 2 inches, e.g. 1.5 inches.

Channel 17 is defined by a common area into which inlets 13, 15, 19, 21 do not protrude. A channel width of around 2 inches is preferred.

Inlets 13, 15, 19, 21 define a corresponding plurality of arms, e.g. arms 12, 14, 16, 18, 20, 22. Arms 12, 14, 16, 18, 20, 22 are adapted to accept a surface for screenprinting. The surface may be a material such as cloth, a sleeve such as for a wearable item, a coozie cup, or the like, or a combination thereof. Each arm will have a width defined by inlets 13, 15, 19, 21. For example, where the length of first substantially planar member 11 is around 13 inches and the inlet gap is around 1.5 inches, each arm will have a width of around 3.25 to 3.375 inches.

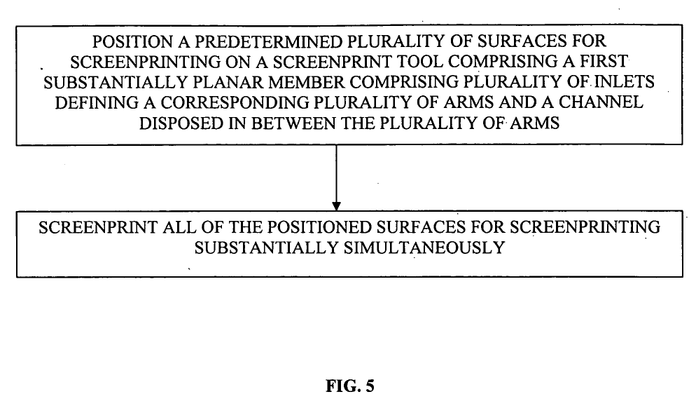

Referring now to FIG. 2 and FIG. 4, second substantially planar member 30 is disposed about a surface of first substantially planar member 10, e.g. on or near its bottom surface. Second substantially planar member 30, in preferred embodiments, has a width that is less than the width of channel 17 and a length that is around the length of channel 17. For example, if channel 17 has a length of around 13 inches and a width of around 2 inches, in a preferred embodiment the length of second substantially planar member 30 may be around 12 inches and the width around 1.75 inches.

Second substantially planar member 30 may comprise any appropriate material, e.g. wood or plastic or metal, and may be secured onto first substantially planar member 10 such as by chemical fasteners such as glue, mechanical fasteners, or the like, or a combination thereof. In certain embodiments, first substantially planar member 10 and substantially planar member 30 may be fabricated as a unitary piece.

Third substantially planar member 40 comprises a width substantially equal to the width of second substantially planar member 30 and a length not greater than a length of the second substantially planar member 40. For example, if channel 17 has a length of around 13 inches and a width of around 2 inches, in a preferred embodiment the length of third substantially planar member 40 may be around 8 inches and the width around 1.75 inches.

Adjuster 50 is adapted to adjustably secure screenprint tool 1 to a supporting surface (not shown in the figures) such as by compressing second supplemental planar member 30 and third substantially planar member 40 about the surface. In the preferred embodiment, adjuster 50 is a threaded adjuster and at least one of second substantially planar member 30 and/or third substantially planar member 40 further comprises a threaded receiver (not shown in the figures) adapted to receive threaded adjuster 50.

In a preferred embodiment, two adjusters 50 are in movable communication with second substantially planar member 30 and third substantially planar member 40.

In the operation of an exemplary embodiment, referring now to FIG. 5, the screenprint tool of the present inventions is secured about a supporting surface by adjusting adjuster 50 until third substantially planar member 40 is snugged about the supporting surface, clamping or otherwise compressing the securing surface in between second substantially planar member 30 and third substantially planar member 40. Alternatively, the third substantially planar member and the second substantially planar member may themselves be compressed about the surface. The supporting surface may be a table or other mounting surface.

Each arm, e.g. arm 12, is adapted to accept a surface for screenprinting where the surface may be material, a sleeve such as on a shirt, a coozie cup, or the like, or a combination therefore. One or more of such surfaces is then positioned on or about a predetermined number of arms, e.g. arms 12, 14, 16, 18, 20, 22. In certain embodiments, a surface for screenprinting may be positioned on or about a plurality of arms 12, 14, 16, 18, 20, 22.

Once in place, all of such positioned surfaces may be screenprinted substantially simultaneously.

It will be understood that various changes in the details, materials, and arrangements of the parts which have been described and illustrated above in order to explain the nature of this invention may be made by those skilled in the art without departing from the principle and scope of the invention as recited in the appended claims.

I claim:

1. A screenprint tool, comprising a first substantially planar member that further comprises:
a. a plurality of inlets defining a plurality of arms, at least one arm adapted to accept a surface for screenprinting; and
b. a channel defined by a common area into which the inlets do not protrude.

2. The screenprint tool of claim 1, wherein each arm of the plurality of arms is adapted to accept a surface for screenprinting.

3. The screenprint tool of claim 1 wherein the surface is at least one of (i) a material, (ii) a sleeve, or (iii) a coozie cup.

4. The screenprint tool of claim 1, further comprising:
a. a second substantially planar member, disposed about a surface of the first planar member and having a width that is less than a width of the channel;
b. a third substantially planar member; and
c. an adjuster in movable communication with the second substantially planar member and the third substantially planar member.

5. The screenprint tool of claim 4, wherein the second substantially planar member is secured to the first substantially planar member by at least one of (a) a chemical fastener or (b) a mechanical fastener.

6. The screenprint tool of claim 4, wherein the first substantially planar member and the second substantially planar member are fabricated as a unitary piece.

7. The screenprint tool of claim 4, wherein the third substantially planar member further comprises:
a. a width substantially equal to the width of the second substantially planar member; and
b. a length not greater than a length of the second substantially planar member

8. The screenprint tool of claim 4, wherein the adjuster is a plurality of adjusters.

9. The screenprint tool of claim 4, wherein the adjuster is a flexible adjuster and the movable communication is a flexible communication.

10. The screenprint tool of claim 4, wherein:
a. the adjuster is a threaded adjuster; and
b. at least one of the second substantially planar member and the third substantially planar member further comprises a threaded receiver adapted to receive the threaded adjuster.

11. The screenprint tool of claim 4, wherein the adjuster is adapted to adjustably secure the screenprint tool to a surface by at least one of (i) compressing the surface in between the third substantially planar member and the second substantially planar member or (ii) compressing the third substantially planar member and the second substantially planar member about the surface.

12. A method of screenprinting, comprising:
a. positioning a predetermined plurality of surfaces for screenprinting on a screenprint tool comprising a first substantially planar member comprising plurality of inlets defining a corresponding plurality of arms and a channel disposed in between the plurality of arms; and
b. screenprinting all of the positioned surfaces for screenprinting substantially simultaneously.

13. The method of claim 12, wherein each of the predetermined number of surfaces for screenprinting is positioned on a single one of the plurality of arms.

14. The method of screenprinting of claim 12, further comprising:
a. positioning the screenprint tool about a supporting surface, the tool further comprising a second substantially planar member secured to the first substantially planar member, a third substantially planar member, and an adjuster in movable communication with the second substantially planar member and the third substantially planar member;
b. positioning a supporting surface in between the second substantially planar member and the third substantially planar member; and
c. securing the tool to the supporting surface by adjusting the adjuster until the screenprint tool is clamped to the supporting surface.

15. The method of claim 14, wherein the supporting surface is at least one of (a) a table or (2) a mounting surface.
